(19) United States
(12) Patent Application Publication
(10) Pub. No.: US 2020/0327498 A1
(43) Pub. Date: Oct. 15, 2020

(54) Business Process Execution on a Blockchain Platform

(71) Applicant: National ICT Australia Limited, Eveleigh, NSW (AU)

(72) Inventors: Ingo Weber, Eveleigh (AU); Xiwei Xu, Eveleigh (AU); Guido Govenatori, Eveleigh (AU); Regis Riveret, Eveleigh (AU); Alexander Ponomerev, Eveleigh (AU)

(21) Appl. No.: 16/087,077

(22) PCT Filed: Mar. 21, 2017
(86) PCT No.: PCT/AU2017/050254

§ 371 Date: Sep. 20, 2018

(30) Foreign Application Priority Data
Mar. 21, 2016 (AU) 2016901059

(51) Int. Cl. G06Q 10/10; G06Q 20/08; G06Q 20/06; G06Q 20/40; G06Q 20/36; G06F 16/23; G06F 16/27; H04L 9/08

(52) U.S. Cl. CPC G06Q 10/10; G06Q 20/085; G06Q 20/0655; G06Q 20/401; G06Q 10/0833; G06Q 20/3678; G06F 16/2379; G06F 16/27; H04L 9/085; G06Q 20/3674

(57) ABSTRACT

Methods and apparatus for utilising a distributed ledger, such as the Ethereum blockchain, to monitor and execute a process instance (170) between parties that may not trust each other. The proposed methods and apparatus integrate blockchain into the choreography of processes in such a way that no central authority is needed, but trust maintained. The combination of a set of components (a translator 160, a process instance 170 and a trigger/interface 120, 130) allows for monitoring or coordination of business processes on the blockchain (150) and off the blockchain (140).

### CROSS-REFERENCE TO RELATED APPLICATIONS

The present application claims priority from Australian Provisional Patent Application No 2016901059 filed on 21 Mar. 2016, the content of which is incorporated herein by reference.

### TECHNICAL FIELD

The present disclosure relates to a computer-implemented method, software, device and system to execute business processes on a blockchain platform.

### BACKGROUND

The Blockchain

The blockchain was designed to be a public shared ledger maintained by all the nodes within a peer-to-peer network. A blockchain platform does not rely on any central trusted authority like traditional banking and payment systems. Instead, trust is achieved as an emergent property from the interactions between nodes within the network. A full copy of the blockchain contains every transaction ever executed within the blockchain network, therefore a party transacting on the blockchain can verify with a high level of certainty that the other party is able to transact as the other party claims. One significant consequence of this is that it is not necessary to utilise a trusted third party such as a bank for a transaction of money.

The blockchain as a concept was initially defined in the infrastructure of Bitcoin. Since then, the concept has been generalised into distributed ledgers that use the blockchain to verify and store any transactions without needing cryptocurrency or tokens. Many cryptocurrencies now use blockchains as the basis of their platform. Popular blockchain platforms include Bitcoin and Ethereum.

Transactions

As above, a blockchain is essentially a list of transactions shared by all nodes participating in a system based on an agreed protocol. Each transaction represents a transfer of a specific quantity of a digital asset from one party's address to another party's address. Thus an address functions similar to a bank account. For example Alice can pay Bob 5 Bitcoins by creating a transaction on the blockchain and transfers the 5 Bitcoins from one of her addresses and specifies Bob's address as the output.

There are different digital assets associated with different blockchain platforms. Typically digital assets are the currency associated with the platform. As a result, the current disclosure utilises currency and digital assets interchangeably. For example the currency of the Bitcoin platform is also known as Bitcoin; the currency of Ethereum is known as Ether. However despite being different currencies they operate in very similar ways due to the fact they are both blockchain platforms.

A full copy of the currency's blockchain contains every transaction ever executed in the currency. A transaction is an identifiable data package that stores an indication of monetary value, and/or parameters and results of function calls in a smart contract. The integrity of the transactions in a blockchain platform is ensured by cryptographic techniques. A computer that is connected to and participating in the blockchain network that contains a full copy of the currency's blockchain is known as a ‘full node’.

Blocks

In blockchain systems, transactions are aggregated into blocks. Each block is also linked to the previous block (the ‘parent’ block) by containing a reference the previous block. This has the effect of creating a chain of blocks from the current block to the very first block known as the genesis block. Each block is guaranteed to come after the previous block chronologically because the previous block's hash would otherwise not be known. Each block is also computationally impractical to modify once it has been in the chain for a while (typically in Bitcoin this is around 60 minutes or 6 blocks on average) because every block after it would also have to be regenerated. These properties are what make double-spending of Ether or Bitcoin very difficult.

Smart Contracts

Smart contracts in a blockchain platform are intended to replicate the legal concept of contracts. That is, where contracts are mutual agreements that impose obligations on the parties to the contract, a smart contract is a way of automatically imposing obligations or conditions on the transaction.

Bitcoin and Ethereum (and most other blockchain platforms) utilise scripts for the purpose of verifying transactions. It is possible that a smart contract can be implemented as a script and it would operate the same as the way a normal transaction would be verified. Although this is the practice that Bitcoin has adopted, this is quite difficult because the script has to execute in order for the transaction to be verified. In Ethereum, smart contracts are distinct from verifying a transaction. As a result smart contracts can exist independently of a transaction that initiated the contract. Other differences include that the smart contract has to be deployed before it can be executed and once deployed the smart contract will execute unless explicitly terminated. In both Bitcoin and Ethereum, the script contains all the function calls (op codes) that are required for the contract to be performed automatically. All nodes on both blockchain platforms execute the script.

There are a number of limitations to the use of scripts in blockchain platforms. One such limitation for Bitcoin is that the scripting language in not Turing-complete. A consequence of this is that a script in Bitcoin cannot contain any loops. This restriction was intended to prevent attackers from running scripts on the Bitcoin system that loop infinitely that act as a Denial of Service (DOS) type of attack. In contrast, Ethereum has a built-in Turing-complete script language for writing smart contracts. The way Ethereum overcomes the potential for a DOS attack is that the parties transacting in the currency are required to pay a fee proportional to the CPU cycles needed by the script (this is known as Gas in Ethereum). A script cannot therefore loop infinitely as the attacker would require an infinite amount of currency to pay for the script to execute.

### SUMMARY

A computer implemented method for generating a script template for execution as a process instance on the blockchain based on a process specification, the method comprising:

(a) determining one or more tasks to be executed in the process instance corresponding to one or more steps in the process specification;

(b) determining one or more triggers to provide the process instance with information of one or more tasks to be executed off-chain corresponding to one or more steps in the process specification; and

(c) generating the script template for execution as the process instance based on the one or more tasks and the one or more triggers.

The method may further comprise initiating a process instance on a blockchain, the method comprising:
generating a script template in accordance with the method described above;
completing the script template by adding parameter values; and
initiating a process instance by executing the script on the blockchain.

The method may further comprise receiving the process specification and wherein the process specification contains the one or more steps.

In the method described above initiating the process instance may include:
populating the script template with specific information of a transaction instance;
propagating the transaction over a peer-to-peer network supporting the blockchain.

The method may further comprise the process instance storing a state of the process instance on the blockchain.

The method described above wherein the process instance determines one or more triggers to be called based on the state of the process instance on the blockchain.

The method described above wherein one or more triggers may call an external interface of a party in a process of the process specification.

The method described above wherein the method further comprises distributing one or more triggers to one or more nodes in a peer-to-peer network supporting the blockchain.

The method described above, wherein step (b) may include any one or more of:
determining one or more sources of information to complete each task;
determining type of information to complete each task;
determining an exit function for each task;
determining one or more data stores for storing data that is external to the blockchain; and
determining a key-sharing arrangement between one or more parties to a process in the process specification.

The method described above may further comprise any one or more of:
reporting activity information to a mediator;
polling execution status of the process instance;
determining an external interface function to execute;
updating process state in the blockchain;
receiving information for each task in the process instance;
triggering a next step in the process instance based on the information received; and
determining a range of total cost of executing the process instance on the blockchain.

The method described above wherein the process instance may be a monitor.

The method described above wherein the process instance may be a mediator.

There is also provided a non-transitory computer readable medium having computer readable instructions for generating a script template for execution as a process instance on the blockchain based on a process specification as described here.

A system for executing a process instance on the blockchain, wherein the process involves one or more parties, the system comprising:
a translator
   to determine one or more tasks to be executed in the process instance corresponding to one or more steps in the process specification;
   to determine one or more triggers to provide the process instance with information of one or more tasks to be executed off-chain and that correspond to one or more steps in the process specification; and
   to generate a script template for execution as the process instance based on the one or more tasks and the triggers.
a process instance that is able to be initiated on the blockchain;
a trigger to communicate with the process instance and an interface;
the interface to communicate with the trigger and external data.

Optional features of the computer method described above are equally optional features of the software and computer system also described here.

### BRIEF DESCRIPTION OF DRAWINGS

Examples of the present disclosure will be described with reference to:

FIG. 1 illustrates an exemplary application scenario.

FIG. 2. illustrates a computer-implemented method for generating a script template for execution as a process instance on the blockchain based on a process specification.

FIG. 3 illustrates an example process specification.

FIG. 4 illustrates an example translator.

FIG. 5 illustrates an example trigger.

FIG. 6. illustrates an example monitor.

FIG. 7 illustrates an example mediator.

### DESCRIPTION OF EMBODIMENTS

The present invention generally relates to methods and apparatus for utilising a distributed ledger, such as the Ethereum blockchain, to monitor and execute a process between parties that may not trust each other. Process execution is problematic if the parties involved have a lack of trust in each other. As a result, if there are several parties in collaboration, it can be hard to make a decision on which organisation should control the process that ties them together. Parties typically would need to trust a central authority or simply take a risk on one of the parties themselves. In this disclosure, a blockchain is utilised to replace a central authority and facilitate a process. The computational infrastructure of blockchain can be used to either monitor or coordinate processes.

In the literature, the term ‘smart contract’ is used interchangeably to refer to both the code that is used to execute a smart contract and the actual executing or executed smart contract. For clarity, in this disclosure the term ‘process instance’ refers to the execution, and services provided by the smart contract. The term ‘script’ refers to the smart contract code that can be executed as a process instance. The term ‘script template’ contains the logic but not the parameters that would make the script executable. A script template becomes a script when the appropriate parameters are filled in.

The current disclosure uses the term ‘blockchain’ to refer to actual blockchain itself (that is, the public shared ledger with blocks added sequentially). The current disclosure also uses the term blockchain in relation to a blockchain platform and a blockchain network. The term ‘blockchain platform’ is intended to refer to all the components that make the blockchain operate. This includes the wallet, code, transactions, the blockchain network, as well as the blockchain itself. Examples of blockchain platforms used in the disclosure include Bitcoin and Ethereum. Where the term blockchain network is used (for example the Ethereum blockchain network), this is intended to refer to the computers running the blockchain code that are able to communicate with each other via a communications network such as the Internet. Computers in the blockchain network are referred to as nodes, and a full node is a computer in the blockchain network that contains a copy of the entire blockchain.

Components

The current disclosure refers to three distinct components. These components are:

The Translator

This is a component that translates an existing process specification to a script template, which is a partly completed script in a blockchain scripting language. Examples of scripting languages for blockchain platforms include Solidity (Ethereum) and Script (Bitcoin). Depending on the requirements, the script template may be designed according to a generic pattern such as a mediator or monitor.

A Process Instance

A script template can be converted into a script by completing the script template with appropriate parameters. The process instance is the execution of the script on the blockchain. This component that performs the function of facilitating the process. Although the script template as above may be generic, as the process instance requires parameters to be set in the script, the process instance is case specific.

A Trigger/Interface

This component connects the blockchain process execution to the outside world. This is a program performed by a computer that may run on a blockchain full node. The interface has a number of functions such as polling the execution status of the process on the blockchain, calling external Application Programmable Interface (API) functions if needed, and updating the process state in the blockchain from external observations.

Example of the System of the Current Disclosure

The following is an illustrative example. Although it describes the use of Ethereum, this is intended simply to be illustrative of a blockchain platform. The primary reason for this is that Ethereum natively supports smart contacts. Smart contracts are account holding objects on the Ethereum blockchain. They contain code functions and can interact with other contracts, create new contracts, make decisions, store data, and send Ether to others.

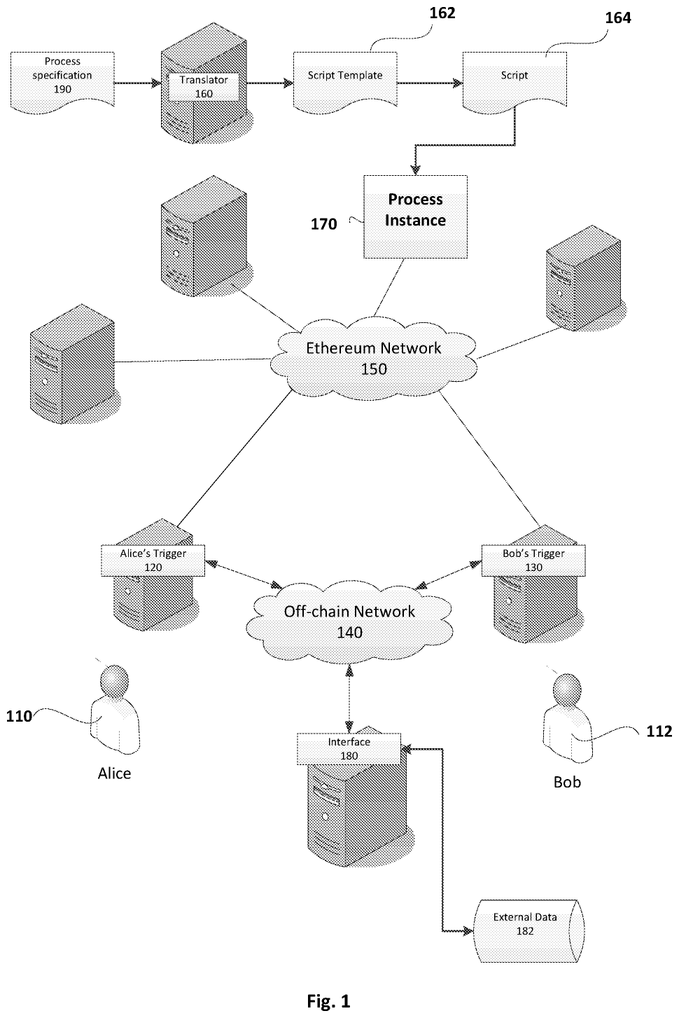

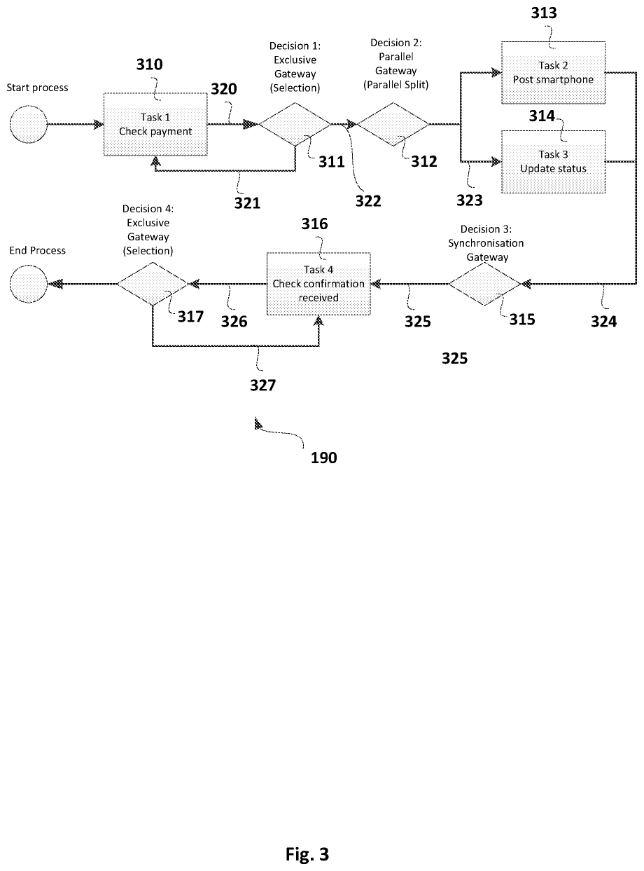

FIG. 1 is an example illustration of the proposed system. In this system, Alice 110 and Bob 112 are partaking in a process where Bob 112 is selling a smartphone and Alice 110 is buying it. In order for the method to proceed, Alice 110 and Bob 112 each have access to a trigger (120, 130) that are computer programs running on a full node in the Ethereum Network 150. Alice 110 and Bob 112 each have a secret key. Alice's trigger 120 has access to Alice's secret key and Bob's trigger 130 has access to Bob's secret key. Although this is the example given, in practice either trigger (120, 130) could be any trigger with the appropriate secret key. In fact it is possible Alice's trigger and Bob's trigger are actually the same computer with both secret keys. In addition, each trigger (120, 130) can call the various functions that are defined in the process instance 170. The translator 160 generates the script template 162 based on an input of a process specification 190. An example process model, which is a diagrammatic representation of a process specification 190 is shown in FIG. 3. The process specification 190 is comprised of a sequence of tasks and decision making logic that produce an output based on input parameters provided.

The translator 160 has the important role of determining which tasks of the process specification 190 can be executed on chain and which tasks can be executed external to the blockchain. The translator 160 takes into account a number of factors to determine whether a task can be executed on-chain or executed off-chain. Where tasks are executed on the blockchain this typically means that one or more functions in a smart contract can be executed and in addition or alternatively one or more transactions occur. A task on the blockchain may potentially cause computational cost in the form of Gas or transaction fees or both. Other relevant factors include a level of trust between the parties of the transaction, the type of task and the data requirements of a specific task.

Types of tasks include physical, data store, state or computational. Physical tasks are tasks that require a tangible object. For example, a sale of real estate requires the existence of property in the form of real estate. Physical tasks will typically have to be performed off-chain but there may be a related on-chain task. In the real estate example, this may be the transfer of title that is include in a digital form in the metadata of a blockchain transaction. A data store type of task is one that stores a data payload either on the blockchain or off-chain. A state type of task is one that would change the state of the executing process instance 170. For example, the process instance 170 may have three potential states: 1. waiting for input from Alice's trigger, 2. waiting for input from Bob's trigger and 3. waiting for input from an external trigger. Input from Alice's trigger 120 could for example cause the state to change from state 1 to state 2. A computational task is one that performs a computation as part of the task. Examples of computational tasks include factorising a number and concatenating two character strings together.

Tasks may also be executed external to the blockchain (also referred to as off-chain). Given that there is both a limitation and a cost associated with the computation in blockchain platforms, some tasks may be performed by an external process that is not being executed on a participant in a blockchain network or, if it is, it is not executed with the purposes of utilising the blockchain functions nor causing any computational cost of utilising the blockchain (such as Gas).

Process Model Example

FIG. 3 is an example illustration of a process model which is a diagrammatic representation of a process specification 190. To continue with the example of the purchase of a smartphone above, there are four tasks in this process model and four execution decisions. Task 1 is to check the payment. This is to ensure that the correct payment is made by Alice. If the correct payment has not been made then Decision 1 determines that the process repeats to check if the payment has been made again. Otherwise the process proceeds to Decision 2. Checking a payment is type of task that can be performed on the blockchain and it is not particularly computationally expensive. Therefore the translator 160 determines that a payment function can be performed on-chain and can only be called by Alice's trigger 120 At this decision point, there are two tasks that need to be completed. Task 2 is the actual posting of the smartphone. Because it is a physical act and not something performed on a computer, task 2 would have to be done off-chain. As a result, a related task of task 3 is required involving updating the status in order for the status of the step of posting the smartphone to be reflected on the blockchain. As a result, the status update is intended to indicate on the blockchain the exact shipping status of the smartphone. The translator 160 determines that task 3 is performed on the blockchain and can only be called by Bob's trigger 130. Decision 4 is a synchronisation point. The smartphone must be shipped and the status updated to shipped before the process can proceed.

Script Template Example

The translator 160 generates a script template 162 from the process specification 190. An example of the script template is shown below.

contract smartphonePurchase {

function payment(participant source, uint32 transactionID) returns (bool r)

{
if !checkSource(source) throw exception(“Invalid function call for participant”,

source);

r = transactionAmount(transactionID) == [parameter: agreed payment value];

}

function setPostageState(participant source, bytes state) {

if !checkSource(source) throw exception(“Invalid function call for participant”,

source);

setState(state);

}

function confirmReceipt(participant source, bool receipt) {

if !checkSource(source) throw exception(“Invalid function call for participant”,

source);

return receipt;

}

In this script template 162, the payment function (function payment (participant source, uint32 transactionID returns (bool r)) is intended to check that the transaction is for the agreed value of the smartphone. This is indicated by the ‘[parameter: agreed payment value].’ As this value may change, this value is not determined yet and will be set later.

As above, the translator 160 has determined that the payment function is a function that is executed on-chain and the payment function can only be called by Alice's Trigger 120. The function setPostageState takes as an input the current state. The state might be for example selected from either ‘Processing’, ‘Packing’ and ‘Shipped’. This function in this example can only be called by Bob's Trigger. The function confirmReceipt takes as an input a Boolean value which Alice's trigger 120 will use to indicate that the smartphone has been received.

Script Example

A script 164 is a complete piece of code that can be executed on the Ethereum network. This is distinct from a script template 162, which is incomplete because it does not contain all the parameters. Continuing with the example above, the script is to replace the [parameter: agreed payment value] in the script template 162 with the value 5. That is, the value of the smartphone is agreed to be 5 Ether. As this is the only parameter that needed to be set, the script 164 is now ready to be compiled and deployed on the Ethereum network 150.

Initiating a Process Instance

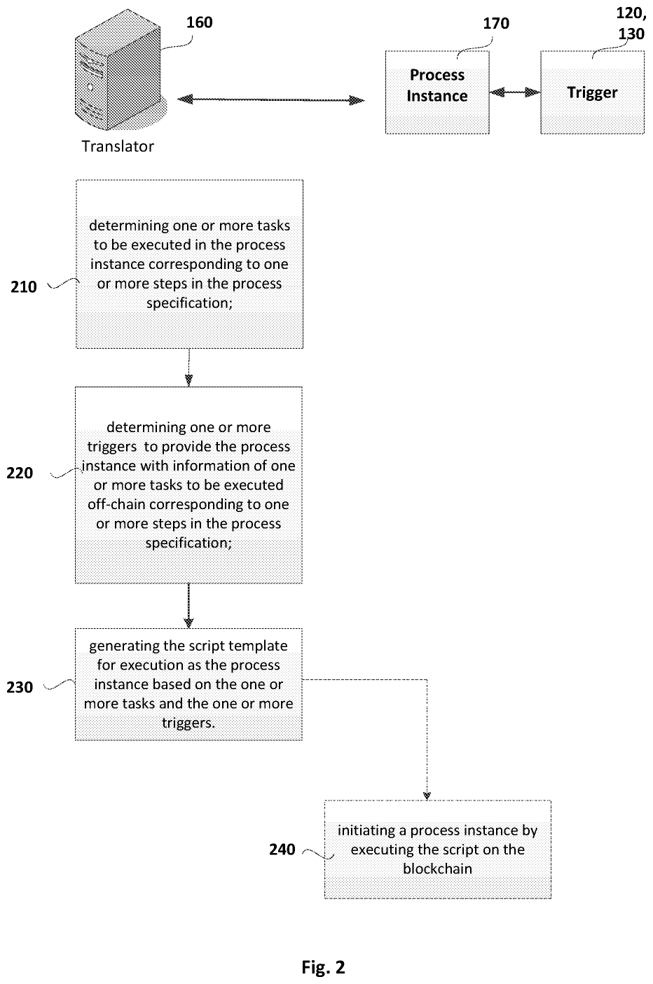

FIG. 2 is an example illustration of a method for initiating a process instance on a blockchain. Initially the translator 160 receives a process specification 210. This process specification may be in any format as long as the translator is able to recognise and process the input. Typical examples of formats for process specifications include BPMN or BPEL. As described above, the translator 160 will identify one or more steps that are required to complete the process as described in the process specification.

The translator 160 then determines 210 one or more tasks to be executed in the process instance 170 that correspond to one or more steps in the process specification 190.

Once the translator 160 has determined 210 the one or more tasks to be executed on the blockchain that correspond to one or more steps in the process specification, the translator may also determine 220 one or more tasks to be executed off-chain and that correspond to one or more steps in the process specification 230. This determination may simply be establishing which of the remaining tasks still need to be executed that have not already been covered by step 210. Although the translator needs to first determine 210 one or more tasks to be executed on the blockchain that correspond to one or more steps in the process specification, it is not a requirement that all tasks need to be determined. For example it may be possible for the translator to determine one task to be executed on the blockchain and then to determine 220 one or more triggers to provide the process instance with information of one or more tasks to be executed off-chain corresponding to one or more steps in the process specification 190. The method may then iteratively repeat 210 and 220 of the method until all the steps in the process completed.

As above, the translator 160 takes into account trust between parties, as a result step 230 may be significantly more complex where issues of trust between parties are not resolved and where the parties are trying to optimise the cost of a transaction. That is, where some tasks are completed off-chain the total cost of using a process instance 170 as a mediator or monitor can be reduced. A consequence of this is that anything that is executed off the blockchain requires a degree of trust between the participants. The degree of trust required is approximately proportional to the significance of the tasks that are executed off-chain.

Once the translator has finished generating a script template for execution as a process instance, the script template can be completed as a script by adding in the remaining parameters and the process instance 170 can be initiated 240 by executing the script on the blockchain. The following is an example of the execution of a script as a process instance 170 in Ethereum. In the Ethereum platform the execution, and services provided by the contract in its executable form as a process instance 170 are provided by the Ethereum network 150 itself. Note that Ethereum smart contracts are, by default, immortal, immutable, and have no owner and as a result once deployed the author of the contract has no special privileges anymore. The smart contracts can be initiated as a process instance 170 as long as the whole network exists, and the process instance 170 will only disappear if the process instance 170 was programmed to self-destruct. Although not provided by default, Solidity—the scripting language for Ethereum—provides a function to kill process instance 170. The translator 160 may include such functionality in the script template where required.

The Translator

The translator 160 is a process that accepts an existing process specification as input (the “workflow”), and generates a smart contract that can be deployed and executed on the blockchain.

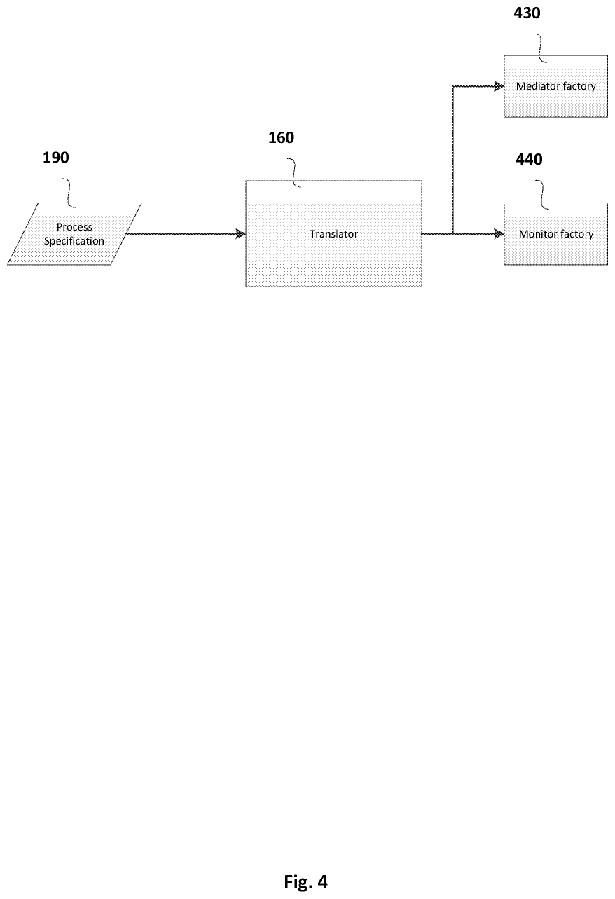

FIG. 4 is an example illustration of a translator 160. In this example, the translator 160 takes as input a process specification 190. The translator then generates two script templates, a mediator factory 430 or a monitor factory 440. A factory 430, 440 in this case is a generic pattern of script template. A generic pattern is a general reusable solution to a commonly occurring problem or scenario. A generic pattern of mediator and monitor allows for new instances of either the monitor or mediator without having to retranslate the process specification 190 again. This means that the process logic will be encapsulated in the script template 162 but it will not contain the actual parameters that would be required to instantiate the process instance 170. In this example, the mediator factory 430 can be used to generate a new mediator when required. Similarly, the monitor factory 440 can be used to generate a new monitor if that is required as well.

The overall translation algorithm follows one of two approaches: (i) token flow-based or (ii) structure tree based. Following either of the high-level approaches provides a way to traverse the process model. The translator 160 contains a number of translation rules that can account for different types of elements. As part of the process of generating the script template, the translator 160 also calculates an output cost of executing the process instance 170.

In one example, the translator 160 can use the control flow in the process specification 190 in order to determine the order of tasks. When using the control flow, the translator 160 converts each of the steps in the process specification to a corresponding task based on one or more patterns of execution below. Alternatively, the translator 160 can determine the relevant pattern of execution of tasks based on the interdependency of the data required for each step. To take a simple example, if the process instance 170 was to perform a mathematical operation of summing the outputs from two independent sources, then there is no interdependency. However, if the process instance 170 was to divide one amount received from one source by the amount received from the other source, then the order of operations is important.

### Translation Algorithm

An example overall translation algorithm has two phases. First, the translator 160 parses the input process specification 190. Then the translator 160 iterates through all the elements (310-317) of the process specification 190, where the translator generates two lists per element in the process specification 190: one list of previous elements and one of next elements. In the example in FIG. 3, the task element 310 would have a list of previous elements including itself [310] and [310,313,314] as the list of next elements.

Then, the translator 160 translates each element with its respective links (320-327), generating code (in this example it generates Solidity code, see above, as this is language used by Ethereum for writing smart contracts) based on the translation rules for different types of elements (see section on patterns of execution for the translator as detailed below). Note that, in the current example implementation, only some combinations of consecutive gateways can be connected to each other without tasks in between but this is not intended to be limiting. The previous element list as described above is used by the translator 160 to determine which other elements need to be deactivated when the current element is executed; the next element list specifies which elements need to be activated after the current element is executed.

The selection methods for the two lists used by the translator 160 are shown in the example Algorithm 1 below. NextElements of an element includes all the tasks that directly follow the element, or the outgoing edge if the target of that edge is an AND-Join. If a next element is a Split or XOR-Join gateway, the tasks edges that connect to it are added into NextElements through a recursive call. PreviousElements of an element includes the element itself. In the case of a Task, if an XOR-Split gateway precedes the current element, the tasks that follow the XOR-Split are added to PreviousElements. In the case of an AND-Join gateway, all incoming edges are added to PreviousElements.

Algorithm 1 Calculating NextElements and PreviousElements.

| | |
|---|---|
| 1: | function SelectNextElements(Element, NextElements[ ]) |

| | |
|---|---|
| 2: | for all Edgeⱼ in outgoingEdges[Element] do |

| | |
|---|---|
| 3: | if Edgeⱼ.targetElement is Task then |

| | |
|---|---|
| 4: | NextElements <− Edgeⱼ.targetElement |

| | |
|---|---|
| 5: | else if Edgeⱼ.targetElement is AND-Join gateway then |

| | |
|---|---|
| 6: | NextElements <−Edgeⱼ |

| | |
|---|---|
| 7: | else if Edgeⱼ.targetElement is Split or XOR-Join gateway then |

| | |
|---|---|
| 8: | SelectNextElements(Edgeⱼ.targetElement, NextElements[ ]) |

| | |
|---|---|
| 9: | end if |

| | |
|---|---|
| 10: | end for |

| | |
|---|---|
| 11: | end function |
| 13: | function SelectPreviousElements(Element, PrevElements[ ]) |

| | |
|---|---|
| 14: | PrevElements<−Element |
| 15: | if Element is Task then |

| | |
|---|---|
| 16: | for all Edgeᵢ in incomingEdges[Element] do |

| | |
|---|---|
| 17: | if Edgeᵢ.sourceElement is XOR-Split gateway then |

| | |
|---|---|
| 18: | SelectNextElements(Edgeᵢ.sourceElement, PrevElements[ ]) |

| | |
|---|---|
| 19: | end if |

| | |
|---|---|
| 20: | end for |

| | |
|---|---|
| 21: | else if Element is AND-Join gateway then |

| | |
|---|---|
| 22: | for all Edgeᵢ in incomingEdges[Element] do |

| | |
|---|---|
| 23: | PrevElements<−Edgeᵢ |

| | |
|---|---|
| 24: | end for |

| | |
|---|---|
| 25: | end if |

| | |
|---|---|
| 26: | end function |

Patterns of Execution for the Translator

A majority of tasks can be matched to five different patterns of execution: sequence, parallel split, synchronisation, join, selection.

Sequence:

In the sequence pattern a task in a workflow is enabled after the completion of another task in the same workflow.

Parallel Split:

A single thread of control splits into multiple threads which can be executed in parallel, so that tasks can be executed simultaneously or in any order.

Synchronisation (AND-Join):

Multiple parallel tasks converge into one single thread of control, thus synchronizing multiple threads.

Join (XOR-Join, Simple Merge):

Multiple parallel tasks converge into one single thread, without synchronisation (cf. synchronisation pattern).

Selection (XOR-Split):

After the completion of a task, a task is selected from one or more alternatives that either (i) satisfies one or more conditions, or (ii) corresponds to the first of the alternatives that is selected.

The smart contract (see Algorithm 2) is generated from the translator 160. In one example, the smart contract contains of a list of storage variables that represent the execution state of the process instance 170 which is the smart contract when executing on the blockchain. To optimise the cost, the size of the data stored on chain can be minimised.

To start the process execution, the first task is activated in Function Init( ). Function Taskᵢ( ) is invoked by the trigger to execute the corresponding task and drive the process. Function JoinGatewayᵢ( ) is invoked internally to enforce the control flow patterns. The storage variables representing the process execution state are manipulated and updated by every function. After the last task is executed, the variable of TerminationActivated is set to be true, which terminates the process.

Algorithm 2 solidity contract.

| | |
|---|---|
| 1: | Bool Task₁Activated <− false |
| 2: | ... |
| 3: | Bool TaskₙActivated <− false |
| 4: | |
| 5: | Bool JoinGateway₁Incoming₁Activated <− false |
| 6: | ... |
| 7: | Bool JoinGateway₁IncomingₙActivated <− false |
| 8: | Bool JoinGatewayₙIncoming₁Activated <− false |
| 9: | ... |
| 10: | Bool JoinGatewayₙIncomingₙActivated <− false |
| 11: | |
| 12: | Bool TerminationActivated <− false |
| 13: | |
| 14: | function Init( ) |

| | |
|---|---|
| 15: | Task₁Activated <− true |

| | |
|---|---|
| 16: | end function |
| 17: | |
| 18: | function Task₁( ) |
| 19: | ... |
| 20: | end function |
| 21: | ... |
| 22: | function Taskₙ( ) |

| | |
|---|---|
| 23: | ... |
| 24: | TerminationActivated <− true |

| | |
|---|---|
| 25: | end function |
| 26: | |
| 27: | function JoinGateway₁( ) |

| | |
|---|---|
| 28: | ... |

| | |
|---|---|
| 29: | end function |
| 30: | ... |
| 31: | function JoinGatewayₙ( ) |

| | |
|---|---|
| 32: | ... |

| | |
|---|---|
| 33: | end function |

Algorithm 3 shows how each task Taskᵢ of a business process is implemented as a function Taskᵢ( ) in Solidity. The function returns a Boolean value that indicates whether the task is completed successfully. The respective “completed” variable defines the execution state of a task; it is stored in the process instance (the executing smart contract) and manipulated by the corresponding Taskᵢ( ) The set of these variables defined the execution state of the process instance. In this example, payment tasks are performed on-chain. Computational tasks, e.g. for data transformation, could be performed on-chain or off-chain, e.g. depending on the outcome of a cost-benefit analysis.

Taskᵢ( ) performs conformance checking when receiving a message to execute Taskᵢ. If conforming (Taskᵢ is activated), the message is forwarded (as smart contract log entry); else, it returns false to indicate that the execution of Taskᵢ has not succeeded and an alert is broadcasted. Once Taskᵢ is successfully executed, all the elements of PreviousElements are deactivated and all the elements of NextElements are activated.

Algorithm 3 Every task is encoded in a function returning a Boolean value.

| | |
|---|---|
| 1: | function Taskᵢ( ) |

| 2: | PreviousElements[ ] | |
|---|---|---|
| 3: | NextElements[ ] | |
| 4: | NextJoins[ ] | //Conformance checking |

| | |
|---|---|
| 5: | if TaskᵢActivated == false then |

| | |
|---|---|
| 6: | return false |

| | |
|---|---|
| 7: | end if |

//Deactivate previous elements

| | |
|---|---|
| 8: | for all Elementₘ in PreviousElements do |

| | |
|---|---|
| 9: | ElementₘActivated <− false |

| | |
|---|---|
| 10: | end for |

//Activate next elements, and invoke followup
checks if the element is a AND-Join gateway

| | |
|---|---|
| 11: | for all Elementₙ in NextElements do |

| | |
|---|---|
| 12: | ElementₙActivated <− true |
| 13: | if Elementₙ is an incoming edge of a AND-Join gateway then |

| | |
|---|---|
| 14: | NextJoins<− Elementⱼ.targetElement |

| | |
|---|---|
| 15: | end if |

| | |
|---|---|
| 16: | end for |
| 17: | for all Joinₖ in NextJoins do |

| | |
|---|---|
| 18: | Joinₖ( ) |

| | |
|---|---|
| 19: | end for |
| 20: | return true |

| | |
|---|---|
| 21: | end function |

Algorithm 4 is an example illustration a Join gateway Joinᵢ of a business process implemented as a function Joinᵢ( ). Similarly as above, the function Joinᵢ( ) starts from conformance checking to make sure that the Join gateway is activated to be executed. The conformance checking is specific to the workflow patterns. For each AND-Join, it checks the condition that all the elements of PreviousElements are activated. After the conformance checking, the gateway is executed, and similarly as above, all the elements of PreviousElements are deactivated and all the elements of NextElements are activated.

After generating the smart contracts, the translator 160 may also calculate the cost range for executing the resulting smart contract. This serves as an indication of how much crypto-coins have to be spent in order to execute process instances over the blockchain.

Algorithm 4 Every AND-Join gateway is encoded in a function.

| | |
|---|---|
| 1: | function Joinᵢ( ) |

| | |
|---|---|
| 2: | PreviousElements[ ] |
| 3: | NextElements[ ] |
| 4: | NextJoins[ ] |
| 5: | Bool Activated <− false |

//Conformance checking for AND-Join

| | |
|---|---|
| 6: | if AND-Join then |

| | |
|---|---|
| 7: | for all Elementₘ in PreviousElements do |

| | |
|---|---|
| 8: | if ElementₘActivated == false then |

| | |
|---|---|
| 9: | return |

| | |
|---|---|
| 10: | end if |

| | |
|---|---|
| 11: | end for |

| | |
|---|---|
| 12: | end if |

//Deactivate previous elements

| | |
|---|---|
| 13: | for all Elementᵢ in PreviousElements do |

| | |
|---|---|
| 14: | ElementᵢActivated <−false |

| | |
|---|---|
| 15: | end for |

//Activate next elements, and invoke followup checks if
the element is an incoming edge of a AND-Join gateway

| | |
|---|---|
| 16: | for all Elementⱼ in NextElements do |

| | |
|---|---|
| 17: | ElementⱼActivated <− true |
| 18: | if Elementⱼ is an incoming edge of a AND-Join gateway then |

| | |
|---|---|
| 19: | NextJoins <− Elementⱼ.targetElement |

| | |
|---|---|
| 20: | end if |

| | |
|---|---|
| 21: | end for |
| 22: | for all Joinₖ in NextJoins do |

| | |
|---|---|
| 23: | Joinₖ( ) |

| | |
|---|---|
| 24: | end for |

| | |
|---|---|
| 25: | end function |

The Trigger

The trigger 120, 130 component queries the execution context of the business processes from the blockchain and can call external Application Programmable Interface (API) functions to drive the process. The trigger is also receptive to API calls from a party wishing to use the trigger to perform functions on the blockchain. Data storage in the blockchain is immutable and therefore records all transactions that are occurring in the business processes. In this way the blockchain forms an audit trail for each involved participant to verify the transactions.

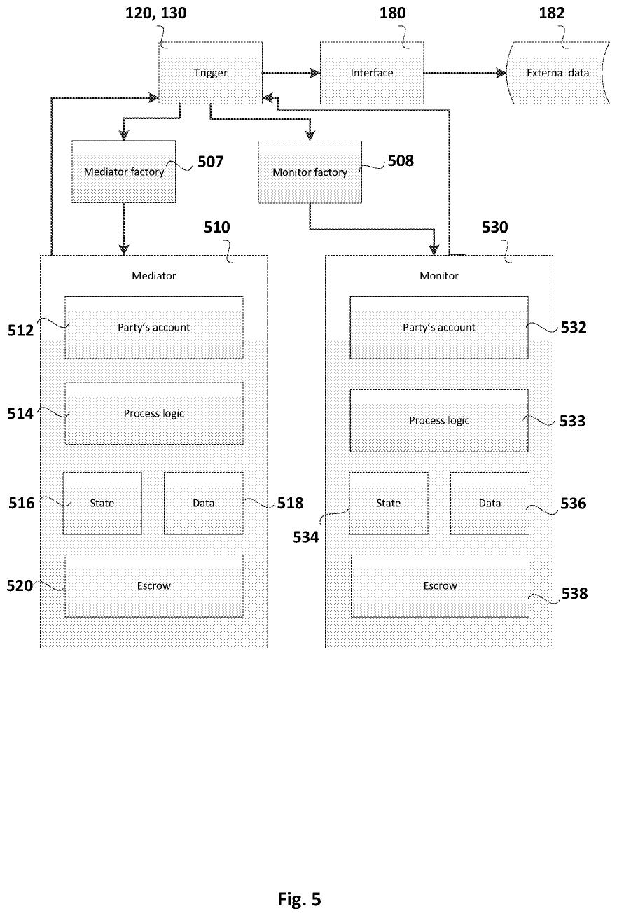

FIG. 5 is an example illustration of a trigger. The trigger 502 is a program that typically resides on a full node of the Ethereum network 150 as a result it is both on the blockchain and off-chain. That is, a trigger is able to perform functions on the blockchain as well as interact external to the blockchain. The trigger 502 is able to freely communicate with the interface 504 which is a program that may be running on the same node or a separate computer. The interface 504 is able to communicate directly with the external data 506. The external data 506 is simply a source of data that is required for the process instance to proceed. The external data 506 may take multiple forms and the specific external data depends on the exact scenario. An example of external data may be storage hardware which is accessible by a node of the network over a communications network. Although not depicted, there can be multiple triggers where each participant in a process communicates with their own trigger (see FIG. 1).

In one example, when a trigger's API is called by a party wishing to use the trigger 120, 130 to interact with the process instance 170 such as Alice 110 or Bob 112, the trigger translates the received message into a blockchain transaction. The trigger may perform local testing on the received message to determine if the message is valid. For example it may test-call a copy of the process instance internally in order to verify the message or to determine the intended result of the process instance 170.

The mediator factory 507 and the monitor factory 508 are the script templates that can be instantiated as a process instance 170 once completed with the parameters. The process instance 570 acts as either a mediator 510 or a monitor 530. The mediator 510 and monitor 530 both contain references to the participants accounts (512, 532), the state of execution (516, 534), data (520, 536) and escrow (520, 538). The mediator also contains process logic 514. The monitor 530 may also contain process logic 533 but it may be simplified logic compared to the process logic of the mediator 514. Typically, the monitor is a passive participant in the process being executed and therefore the monitor may check any messages and forward the message.

The trigger 120,130 is a program that may run on the full nodes of the blockchain network. One or more triggers can preferably be distributed on multiple full nodes, for example, every party can have its own trigger deployed on its own node, and each party only communicates with its own trigger. If necessary, a trigger can be also deployed on one full node, although it is not preferred since a single trigger introduces centralisation and single point failure.

The trigger 120, 130 listens for any transactions that utilise a form that is recognisable to the trigger. One example way in which the trigger can be triggered by a process on the blockchain is as follows. When the process instance 170 receives a message the process instance 170 may store the message on its state of execution status log 516, 534. The state of execution status log is visible to all. As a result, any triggers that are (acting for) parties to the transaction listen to the execution status log of the process instance 170 to determine if the message is designated for the trigger. For example, Alice's trigger 120 may recognise that its public key has been utilised or Bob's trigger 130 may recognise that the message content relates to the next task to be performed by Bob's trigger. The process instance 170 that may also write to the data 520, 536 additional data associated with a specific operation that the trigger should perform or the location where the trigger may acquire the data from in order to perform the specified operation. If the process instance is being used as an escrow, the escrow 520, 538 may check the amount of the digital asset that is transferred.

If a trigger 120, 130 is activated with an operation to store data such as the execution stack, the trigger can execute a transaction and include as part of the metadata of the transaction the relevant data to be stored. There are transaction costs associated with storing the data in this way. Where the data to be stored requires more than one transaction due to the limitations of the transaction size or metadata limits, the trigger may execute more than one transaction. Typically, a range of expected total costs would be calculated beforehand by the translator. The exact cost depends on the tasks and decisions which the process instance 170 executes. However, where the cost is more than expected a mediator may actively seek extra funds or digital assets from the parties in order for the process to continue execution.

Example of a Generic Pattern: Monitor

A script template can be generated according to different generic patterns. One such example is known as a monitor 530. Another example of a generic pattern known as mediator 510 is described below.

In the monitor pattern, the smart contract is a passive party to the transaction. That is, the monitor simply listens to the transactions and acts as a relay by forwarding on messages to the parties. Unlike the mediator described below the monitor is passive and the primary function of the monitor is to store the messages it receives on the blockchain. As such the monitor 510 offers a consolidated view of the state of the execution of the process to the parties of the process as well as any interested third parties. Although the monitor 510 is passive, it may also check that the messages are sent and functions called in an order that conforms with the order of steps in a process as defined in the process specification 190. In addition, if the monitor is being used with escrow, the amount of the digital asset that is transferred may be checked.

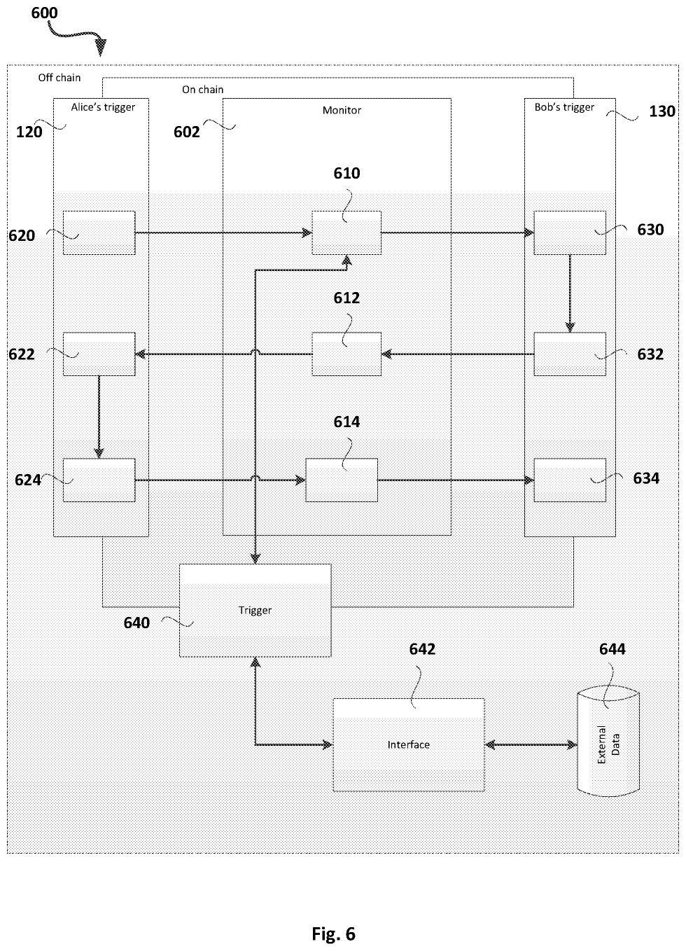

FIG. 6 is an example illustration of a monitor. Continuing the above example, Bob 112 is selling a smartphone and Alice 110 wishes to purchase it. Alice 110 and Bob 112 partially trust each other and therefore intend to use a monitor just in case something goes wrong in the transaction. Once the monitor 602 is initiated the transaction can begin. Initially, Alice 110 wishes to transfer 5 Ether to Bob 112 to purchase the smartphone. The process 620 calls the function payment (see above) to indicate that Alice has transferred 5 Ether to Bob 112. As this and all the subsequent messages, the monitor 602 acts as an intermediary such that neither Alice nor Bob directly send messages to each other.

The first monitor process 610 listens for the function call from the process 620. Therefore when the monitor receives the function call regarding the payment of 5 Ether to Bob, the monitor process 610 will then forward this message to Bob's process 630 by calling Bob's trigger 130. The monitor can store the state of the process instance at this point 610 and at all subsequence points where the monitor is called, 612 and 614. The state of the monitor 602 is inherently stored in the process instance 170. That is, the state of the process instance 170 is maintained by the Ethereum network and thus any changes in the state of the process instance 170 are reflected as changes in the state of the monitor 602. In addition, the monitor 602 may call a trigger 640 to store a data payload. The trigger 640 may then call an interface 642 to access a source of external data 642. Although the use of a trigger 640 is not necessary, a trigger of a trusted third party (such as a trustee) can be used to verify the process.

Once Bob's first monitoring process 630 has received the 5 Ether, Bob's process 630 can begin the actual transfer of the smartphone. The actual transfer may involve typical postage and handling aspects such as packing, posting or couriering the item. This aspect of the transfer would be completed off-chain but the process 630 may wait until it receives a message that the smartphone has shipped.

Bob's trigger 130 process 632 will send the message that the smartphone has been shipped to Alice. The monitor process 612 will listen for the message from Bob that the smartphone has shipped. It will then forward this message to Alice's process 622. Process 622 will then check if the smartphone has been received. Once the smartphone has been received the process 624 will then send a confirmation message to Bob. This message will be received by the monitor process 614 and then the monitor process 614 will send the confirmation to Bob's process 634.

There may be additional messages that Alice and Bob may wish to send to each other. For example, Bob may wish to send Alice periodic updates as to the postage and handling aspects of the smartphone such as indicating that the smartphone has been packaged, shipped, couriered, ready for delivery and/or ready for pickup.

Example of a Generic Pattern: Mediator

Another example of a generic pattern that can be executed on the blockchain is a mediator. When the mediator is initialised as a process instance 170, the process instance can automatically check any defined conditions and transfer a digital asset according to the defined rules. For example, Alice needs to pay Bob at a certain point. In this case, the smart contract has one function that transfers the money to Bob and only Alice has the permission to call this function. The process instance determines under what conditions the money can be transferred and how the money should be transferred. The process starts from Alice transferring money to the process instance. When the money is transferred to Bob could be based on a specific status of the process execution, for example, completion of an certain activity. In addition, the money can be split to pay multiple accounts. For example, in the case that there is a middle man between Alice and Bob, the commission fee of the middle man can be paid by the process instance as well.

When a new process instance is initiated, the account address of all the participants is passed to the trigger. During the process execution, when an activity is completed, the output data payload may be stored in an off-chain data store such as Amazon Web Services. The trigger may update the executing process instance with the process status and hash of the output data payload. In addition, the trigger could get the information of the next step from the mediator contract. The trigger get the input data payload of the next step through manipulating the output data payload of the previous step and call the next step. Again, the input data payload can be stored in an off-chain data store such as Amazon Web Services.

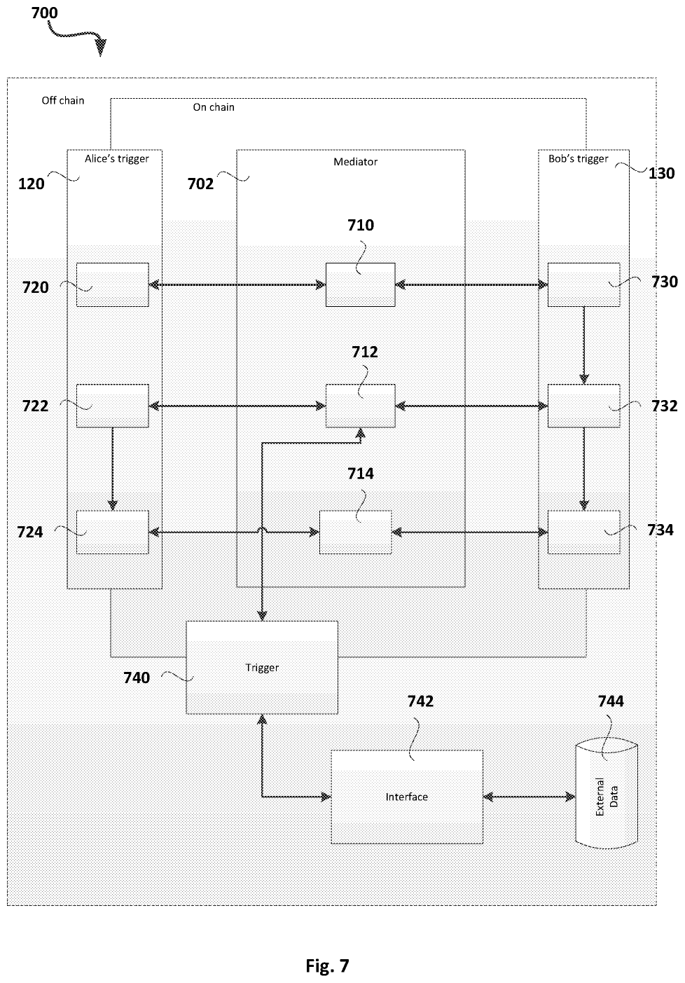

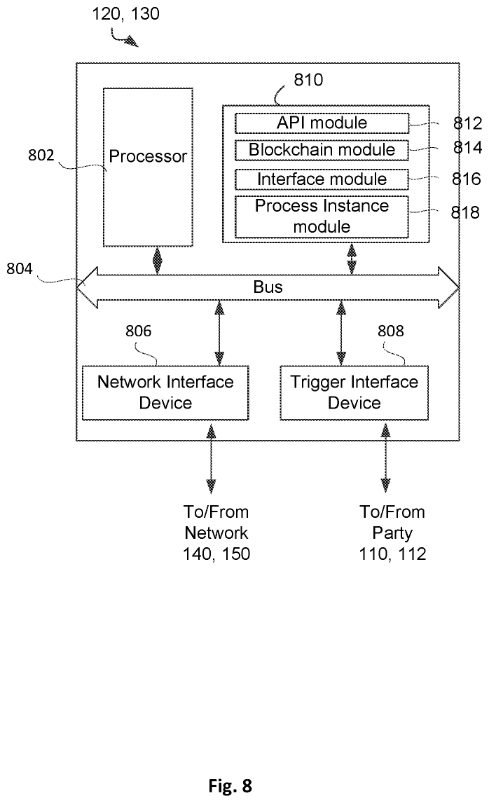

FIG. 7 illustrates an example mediator scenario. In this example, all steps of a process between two parties are communicated to the executing smart contract (‘the mediator’), the mediator is then able to check the state of execution and trigger any steps that are required to be executed off the blockchain.

In the example scenario 700 (similar to scenario 600), Bob is selling a smartphone and Alice wishes to purchase it. Alice 110 and Bob 112 do not trust each other and therefore intend to use a mediator. Once the mediator 702 is deployed the transaction can begin. Initially, Alice wishes to transfer 5 Ether to Bob 130 to purchase the smartphone. The process 720 sends a message that Alice has transferred 5 Ether to Bob 112. Similarly to the monitor above, and as with all the subsequent messages, the mediator 702 acts as an intermediary such that neither Alice's trigger 120 nor Bob's trigger 130 directly send messages to each other. The first monitor process 710 listens to the output from the process 720. The first mediator process 710 may be able to establish that Alice has in fact transferred the 5 Ether. The mediator will then send a payment verification message to Bob's first process 730.

Once Bob's first process 730 has received a verification message, Bob's process 730 can begin the actual transfer of the smartphone. The actual transfer may involve typical postage and handling aspects such as packing, posting or couriering the item. This aspect of the transfer would be completed off-chain but the process 730 may wait until it receives a message that the smartphone has shipped. Process 730 may then send a message to the mediator process 712 to indicate the smartphone has shipped. The mediator process 712 may be able to check the status of the smartphone to verify that Bob has in fact shipped the smartphone. For example, the mediator process 712 may be provided the tracking number of the item and the details of the courier service from Bob's process 732. The mediator process 712 may then perform a transaction in Ether that a third trigger 740 would recognise. The third trigger 740 would then use the interface 742 to determine the correct status of the item by examining the external data 744. In this example, the external data 744 may be the website of the courier service as provided by the process 732 above. The third trigger 740 will then be able to verify that the smartphone has shipped. In this example, the third trigger 740, interface 742 and external data 744 may be the role of a courier or a trusted third party (such as a trustee).

It will then forward a verification message to Alice's process 722. Once the smartphone has been received the process 724 will then send a confirmation message to Bob. This message will be received by the mediator process 714. Mediator process 714 may use the trigger 740 and the interface 742 to verify that the smartphone has been received. The interface 742 may be able to verify this by checking from the external data 744 that the courier service has delivered the item and received a signature. Once verified, the mediator process 714 will send the confirmation to Bob's process 734.

Initiating a Process Instance

In Ethereum, a smart contract has to be deployed before it can be executed. To deploy the smart contract as a process instance, the compiled code of the script and the Application Binary Interface (ABI) are required. The ABI is a Javascript Object that defines how to interact with the process instance 170. Whereas an API defines an interface for source code to be utilised, an ABI defines the low-level binary interface between two or more pieces of software on a particular architecture. The ABI defines how the process instance will interact with itself, how the process instance interacts with the Ethereum network 150, and how the process instance 170 interacts with any code libraries. When compiling the smart contract script, a compiler will typically produce both the compiled code and the ABI. Both Alice's trigger 120 and Bob's trigger 130 may have access to the ABI for the process instance 170 so that it can interact with the process instance 170.

Encryption and Key Distribution.

All the information on blockchain is publicly accessible to all nodes within the network. To preserve the privacy of the involved parties, there is an option to encrypt the data payload before inserting the information into the blockchain. However, the process execution status is not encrypted because the monitors and mediators need to process this information. Encrypting the data payload means that mediators cannot perform data transformation at all, but can resort to the source parties' triggers 120,130 for this task.

The involved parties 110,112 exchange their public keys with each other before a process instance 170 being initiated by one of the involved parties. Thus, the key distribution is handled off-chain. Encrypting a data payload for all process parties can be achieved as follows.

One party, Alice 110 creates a secret key for the process instance 170, and distributes it during initial key exchange. When Alice 110 or Bob 112 adds data payload to the blockchain, it first synchronously encrypts this information using the secret key. Thus, the publicly accessible information on blockchain is encrypted and therefore is not accessible to anyone who has no access to the secret key. The parties involved in the process instance have the secret key and can decrypt the information. Encrypting data payload between two process parties, in contrast, may be desired if two parties want to exchange information privately through the process instance 170. As an example the sender Alice 110 can asynchronously encrypt the information using the receiver Bob's 112 public key; only Bob 112 can decrypt it with his private key.

Example Trigger

The trigger 120, 130 shown in FIG. 8 includes a processor 802, a memory 810, a network interface device 806 and a trigger interface device 808 that communicate with each other via a bus 804. The memory stores instructions 812, 814, 816 and 818 and data for the processes described with reference to FIGS. 1 to 7, and the processor performs the instructions from the memory to implement the processes.

The processor 802 performs the instructions stored on memory 810. Processor 802 receives a trigger API call by a party to the process from the trigger interface device 808. Processor 802 determines an instruction according to the API module 812. The instruction may be a function to communicate with the process instance, in which case the processor 802 performs the instructions stored in the process instance module 818. As the trigger 120,130 is typically a node on the blockchain network the processor 802 may execute instructions stored in the blockchain module 814 to perform the trigger's function as a full node on the blockchain. The processor 802 may execute instructions stored in the interface module 816 to communicate with an interface 180 on the off chain network 140.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A method for generating a script template for execution as a process instance on the blockchain based on a process specification, the method comprising:
determining one or more tasks to be executed in the process instance corresponding to one or more steps in the process specification;
determining one or more triggers to provide the process instance with information of one or more tasks to be executed off-chain corresponding to one or more steps in the process specification; and
generating the script template for execution as the process instance based on the one or more tasks and the one or more triggers.

2. A method for initiating a process instance on a blockchain involving one or more parties, the method comprising:
generating a script template in accordance with claim 1;
completing the script template by adding parameter values; and
initiating a process instance by executing the script on the blockchain.

3. A method according to claim 1, wherein the method further comprises receiving the process specification and wherein the process specification contains the one or more steps.

4. A method according to claim 2, wherein initiating the process instance includes:
populating the script template with specific information of a transaction instance;
propagating the transaction over a peer-to-peer network supporting the blockchain.

5. A method according to claim 1, wherein the method further comprises the process instance storing a state of the process instance on the blockchain.

6. A method according to claim 5, wherein the process instance determines one or more triggers to be called based on the state of the process instance on the blockchain.

7. A method according to claim 1, wherein one or more triggers call an external interface of a party involved in the process instance.

8. A method according to claim 1, comprising distributing one or more triggers to one or more nodes in a peer-to-peer network supporting the blockchain.

9. A method according to claim 1, wherein step (b) includes any one or more of:
determining one or more sources of information to complete each task;
determining type of information to complete each task;
determining an exit function for each task;
determining one or more data stores for storing data that is external to the blockchain; and
determining a key-sharing arrangement between one or more parties to a process in the process specification.

10. A method according to claim 1, further comprising any one or more of:
reporting activity information to a mediator;
polling execution status of the process instance;
determining an external interface function to execute;
updating process state in the blockchain;
receiving information for each task in the process instance;
triggering a next step in the process instance based on the information received; and
determining a range of total cost of executing the process instance on the blockchain.

11. A method according to claim 1, wherein the process instance is a monitor and wherein the monitor listens to the transactions and stores the state of execution.

12. A method according to claim 1, wherein the process instance is a mediator and wherein the mediator performs process logic that is independent of the process logic of the parties to the process instance.

13. A method according to claim 1, wherein a trigger initiates a process instance by executing the script on the blockchain.

14. Machine readable media other than a transitory signal, the machine readable media configured to store instructions for generating a script template for execution as a process instance on the blockchain based on a process specification according to claim 1.

15. A system for executing a process instance on the blockchain, wherein the process involves one or more parties, the system comprising:
a translator
to determine one or more tasks to be executed in the process instance corresponding to one or more steps in the process specification;
to determine one or more triggers to provide the process instance with information of one or more tasks to be executed off-chain and that correspond to one or more steps in the process specification; and
to generate a script template for execution as the process instance based on the one or more tasks and the one or more triggers;
the process instance able to be initiated on the blockchain;
the one or more triggers to communicate with the process instance and an interface; and
the interface to communicate with the one or more triggers.
